(19) United States
(12) Patent Application Publication
(10) Pub. No.: US 2006/0132440 A1
(43) Pub. Date: Jun. 22, 2006

(54) Mouse input device with secondary input device

(76) Inventor: Max Safai, Los Altos, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/021,080

(22) Filed: Dec. 22, 2004

(51) Int. Cl. G09G 5/08

(52) U.S. Cl. 345/163

(57) ABSTRACT

A mouse input device includes a tracking device and a secondary input device. The tracking device tracks movement of the mouse input device over an underlying surface. The secondary input device is located on a surface of the mouse input device. The secondary input device has a sliding structure. A magnitude and a direction of motion of the sliding structure with respect to the surface of the mouse input device is monitored.

### BACKGROUND

A pointing device is often used with computing devices for making selections and for controlling the position of a cursor on a computer display. For example, a mouse input device is a hand held object that is moved over a flat surface to control the motion of a cursor on the computer display. The direction and distance over which the mouse is moved determines the direction and distance the cursor moves on the display. One or more buttons on top of the mouse allow for a user to make various selections. When a workspace is not large enough to provide a path over which the mouse can move and accommodate a desired cursor movement on the display, the user can pick up the mouse and re-center the mouse in the workspace.

A scroll wheel on a computer mouse can be used to move an image relative to a display screen of a host computer. A scroll wheel is normally rotated about a first, transversely extending axis which is secured within a housing for the mouse. Scroll wheels are typically used to scroll an image up and down (vertically) relative to the display screen. In some models, when the user presses the scroll wheel in, the cursor shape changes from a pointer to a four-way arrow. While the cursor is represented as a four-way arrow, movement of the mouse results in the active window in the display being scrolled up-and-down and/or side-to-side. Some mice include a second, separate scroll wheel that is used to scroll an image left and right. In this case, the two independently operable scroll wheels are typically oriented so that they rotate in perpendicular planes.

Additional types of pointing devices are also used with computing systems. For example, a trackball tracks rotational movement of a ball mounted on a keyboard or mounted separate from the keyboard. Movement of the ball controls motion of the cursor. Other pointing devices available for use with computing systems include, for example, the Synaptics capacitive TouchPad™ and the IBM TrackPoint™.

### SUMMARY OF THE DISCLOSURE

In accordance with an embodiment of the present invention, a mouse input device includes a tracking device and a secondary input device. The tracking device tracks movement of the mouse input device over an underlying surface. The secondary input device is located on a surface of the mouse input device. The secondary input device has a sliding structure. A magnitude and a direction of motion of the sliding structure with respect to the surface of the mouse input device is monitored.

### BRIEF DESCRIPTION OF THE DRAWINGS

FIG. 1 shows a top view of a mouse having a secondary input device in accordance with an embodiment of the present invention.

FIG. 2 shows a bottom view of the mouse shown in FIG. 1.

FIG. 3 provides additional detail in a topview of the secondary input device shown in FIG. 1 in accordance with an embodiment of the present invention.

FIG. 4 provides additional detail in a topview of the secondary input device shown in FIG. 1 in accordance with an embodiment of the present invention.

FIG. 5 illustrates motion and operation of the secondary input device shown in FIG. 1 in accordance with an embodiment of the present invention.

FIG. 6 is a block diagram showing a simplified model of electrical operation of the secondary input device shown in FIG. 1 in accordance with an embodiment of the present invention.

FIG. 7 is a block diagram showing integration of electrical components of the secondary input device with other components of the mouse shown in FIG. 1 in accordance with an embodiment of the present invention.

FIG. 8 and FIG. 9 illustrate panning within a computer window in accordance with an embodiment of the present invention.

### DESCRIPTION OF THE EMBODIMENT

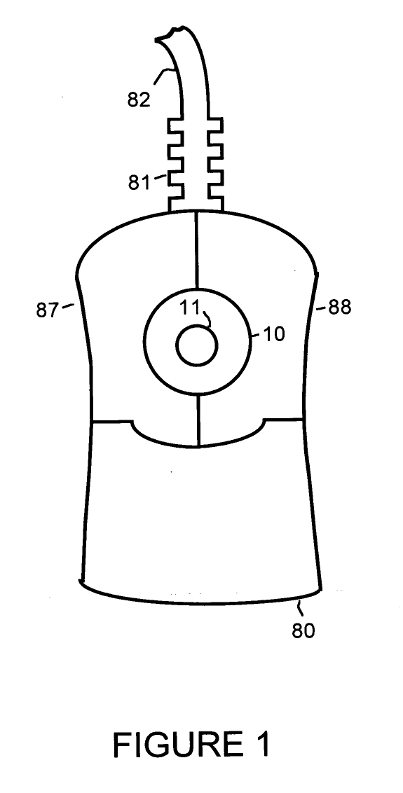

FIG. 1 is a simplified view of the top of a mouse 80. Mouse 80 includes a button 87 and a button 88. Motion of mouse 80 on an underlying surface and depression of selection of buttons 87 and 88 by a user serve as the primary form of user input from mouse 80. Mouse 80 also includes a secondary input device 10. As shown in FIG. 1, secondary input device 10 includes a sliding structure 11. A connecting cable 82 and strain relief 81 are also shown. Alternatively, mouse 80 can be a wireless mouse and connecting cable 82 can be omitted.

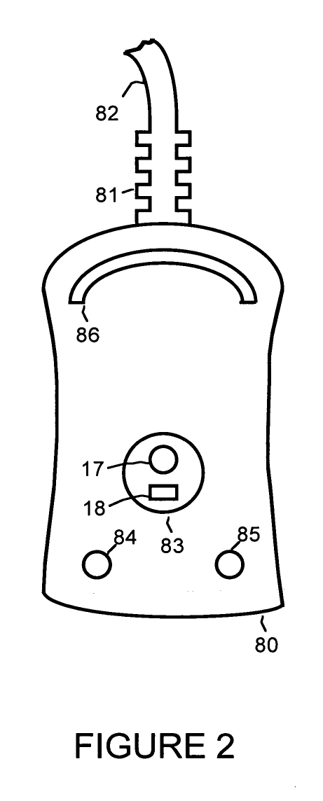

FIG. 2 is a simplified view of the underside of mouse 80. For example, mouse 80 is an optical mouse. A low friction guide 84, a low friction guide 85 and a low friction guide 86 are used by mouse 80 to make contact with an underlying surface. Within an orifice 83 is shown an illuminator 17 and an image array 18. For example, various optics, as necessary or desirable, are included within illuminator 17 and/or image array 18. For example, illuminator 17 is implemented using a light emitting diode (LED), an infrared (IR) LED, or a laser. Alternatively, mouse 80 can be implemented as a traditional mouse with a roll ball, or can be implemented with another technology used to track position of mouse 80 on a surface.

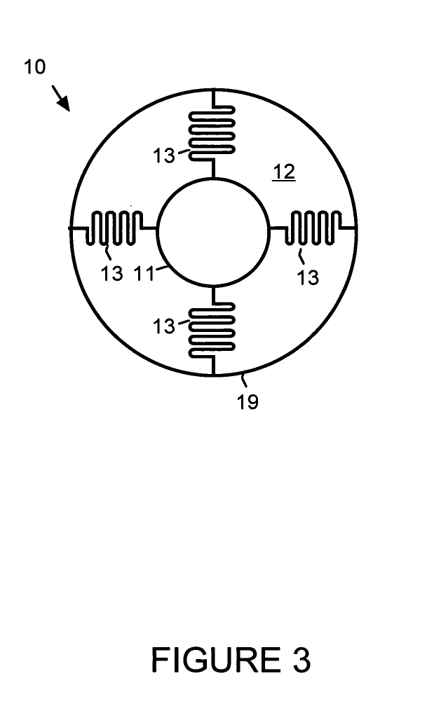

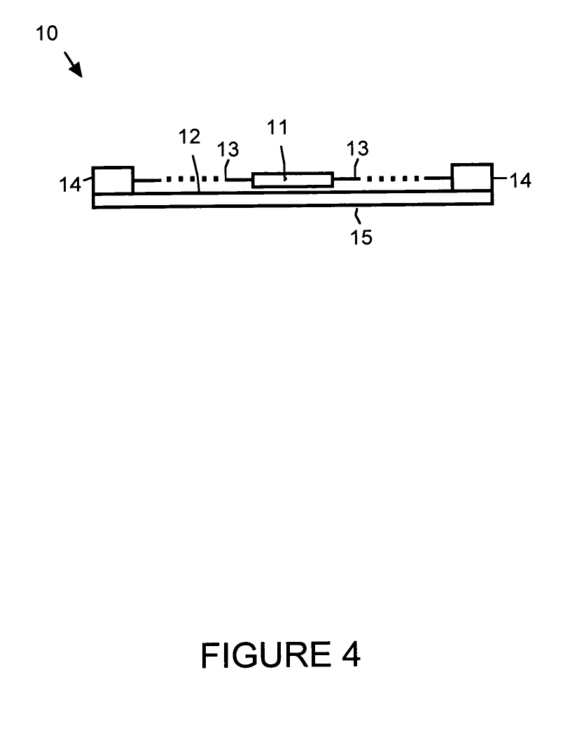

FIG. 3 shows a top view showing additional detail of secondary input device 10. FIG. 4 shows a side view showing additional detail of secondary input device 10. Secondary input device 10 includes sliding structure 11 that moves over a surface 12 of a substrate 15 within a sliding structure field of motion defined by a ring 19. As more fully described below, what is meant by a sliding structure is any object that can be moved by a user over surface 12 of substrate 15 within a predefined field of motion such as that defined by ring 19.

Sliding structure 11 moves in response to a lateral force applied to sliding structure 11. The force is typically applied to sliding structure 11 by a user's finger, finger tip, thumb, thumb tip or multiple fingers. Sliding structure 11 includes a pressure sensing mechanism that measures the vertical pressure applied to sliding structure 11. In addition, secondary input device 10 includes a sensing mechanism for determining the position of sliding structure 11 on surface 12.

For example, when the user applies a vertical force to sliding structure 11 that is greater than a predetermined threshold, any change in the position of sliding structure 11 on surface 12 is reported to a controller within mouse 80. For example, the change in position of sliding structure 11 is used to pan contents of an active window on a computer display by a magnitude and a direction that depends on the magnitude and direction of the motion of sliding structure 11 while the vertical force is applied to sliding structure 11. Secondary input device 10 can also be used for zooming and 360 degree panning other functions. This allows significantly more flexibility that a scroll wheel that only controls movement of an image in a single direction. Secondary input device 10 can be used for gaming, graphical applications, replacement of a tilt wheel, wake-up functions, pitch, yaw, aiming, gaze angle, two-dimensional scroll function and click replacement.

Mechanisms other than vertical pressure can be utilized to activate secondary input device 10. For example, the presence of the user's finger on the sliding structure can be sensed using capacitance differentials. For example, the presence of the user's finger measurably alters the capacitance of one or more electrodes on the sliding structure. Alternatively, an activation sensor can be implemented without a separate vertical force or capacitance sensor, but rather by software analysis of the sliding structure x and y positions. When sliding structure 11 is snapping back to the center under the force of re-centering springs, the direction and acceleration of the sliding structure motion can be used to determine if the sliding structure is being manipulated by the user or is just under the influence of a centering device.

When the user releases sliding structure 11 by removing the user's finger, sliding structure 11 is returned to its centered position by springs 13. Springs 13 connect sliding structure 11 to sides 14 of the sliding structure field of motion. Since the user's finger is not applying a vertical force to sliding structure 11 during its return, the change in position associated with that return motion is not reported to the host device. That is, cursor 101 remains at location 102. This provides a convenient “re-centering” capability.

For example springs 13 are implemented as meander springs. Alternatively, springs 13 can be implemented as common helical coiled springs. Alternatively, springs 13 can be implemented using a spiral spring design. While FIG. 3 shows utilization of four springs for restoring sliding structure 11 to its resting position, other numbers of springs can be utilized. In principle, one spring could be used; however, the spring would need to provide the return force in two directions, and hence, would no longer be isotropic, and would be much stiffer than the springs described above. In addition, more springs can be used to provide additional electrical connections to the sliding structure.

Springs 13 ideally return sliding structure 11 to a resting position that is in the center of the field of motion. However, sliding structure 11 need not be returned exactly to the same starting position each time it is released. Similarly, sliding structure 11 need not return to a resting position that is exactly in the center of the sliding structure field of motion. When sliding structure 11 does not return to a center position, it may be desirable to calibrate springs 13 or any other mechanism used to restore sliding structure 11 to its resting position. Alternatively, an auto-calibration mechanism can be included to perform this calibration.

Springs 13 can be replaced, for example, by other mechanisms for restoring sliding structure 11 to its resting position. For example, the sliding structure may include a magnet that is attracted to a corresponding magnet within the substrate under the sliding structure.

Alternatively, embodiments of the present invention can be constructed in which the restoring mechanism is the user's finger. In such an embodiment, the user would reduce the pressure on the sliding structure to a level below the level at which the coupling of the sliding structure to the cursor occurs. The user can then move the sliding structure to a new location manually without engaging the cursor on the display. The user can then continue the cursor movement by once again pressing on the sliding structure with sufficient pressure to activate the coupling of the sliding structure and the cursor.

While FIG. 3 shows a sliding structure field of motion that is circular, the sliding structure field of motion can have other shapes. For example, the sliding structure field of motion can be elliptical or rectangular. In these cases, the optimal spring shapes will be different than those described above.

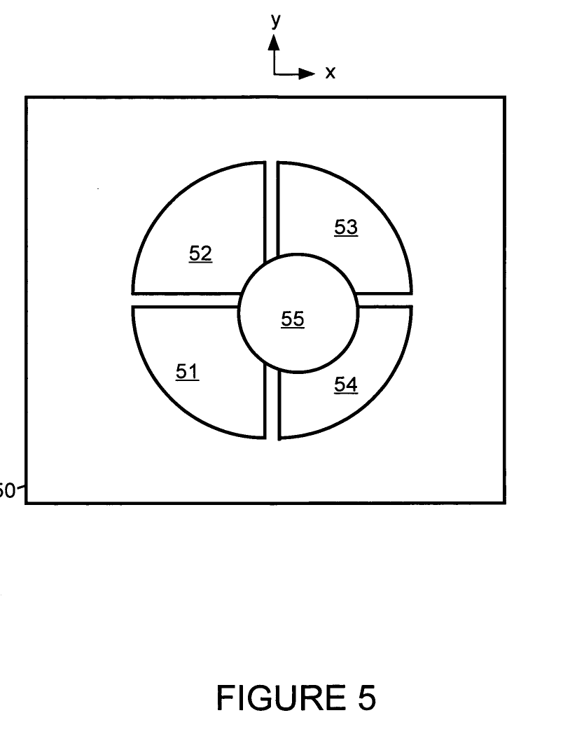

FIG. 5 illustrates motion and operation of secondary input device 10 shown in FIGS. 3 and 4. For example, sliding structure 11 (shown in FIG. 3) includes a sliding structure electrode 55, shown in FIG. 5. Surface 12 (also shown in FIG. 3) includes an electrode 51, an electrode 52, an electrode 53 and an electrode 54, shown in FIG. 5. Electrodes 51 through 54 have terminals that are connected to an external circuit. To simplify the drawing, these terminals have been omitted. Sliding structure electrode 55 is located on a bottom of sliding structure 11 (shown in FIG. 3). Electrodes 51 through 55 are electrically isolated from one another. For example, sliding structure electrode 55 can be covered with a layer of dielectric that provides the required insulation while still allowing sliding structure electrode 55 to slide over the electrodes 51 through 54. Alternatively, electrodes 51 through 54 can be patterned on the back of substrate 15 (shown in FIG. 4). This reduces the capacitance between the electrodes 51 through 54 and sliding structure electrode 55, but can be practical for substrate thicknesses a few millimeters or less.

The overlap between sliding structure electrode 55 and each of electrodes 51 through 54 depends on the position of the sliding structure relative to electrodes 51 through 54. As illustrated in FIG. 5, sliding structure electrode 55 is off center so that sliding structure electrode 55 covers more of electrode 54, than sliding structure electrode 55 covers of electrode 51, electrode 52 or electrode 53.

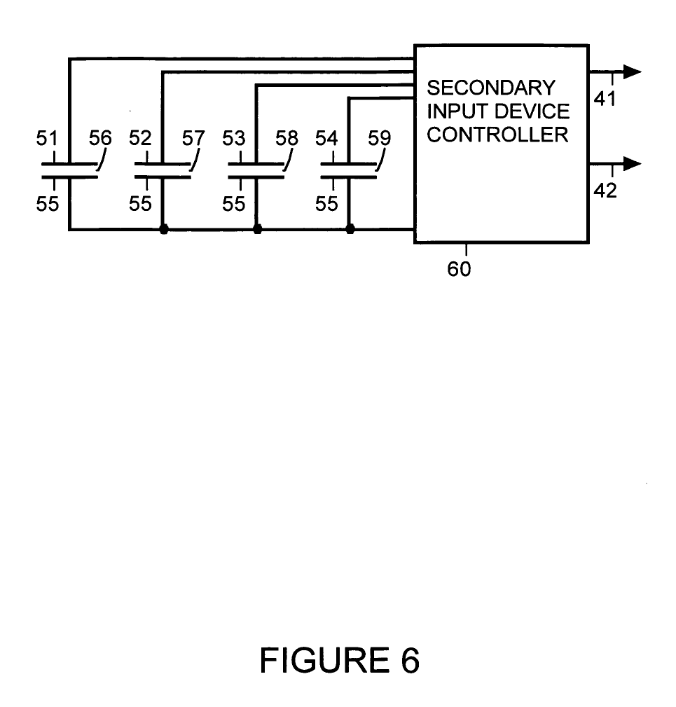

FIG. 6 is a block diagram showing a simplified model of electrical operation of secondary input device 10. Each of electrodes 51 through 54 forms a capacitor with a portion of sliding structure electrode 55. For example, electrode 51 and a portion of sliding structure electrode 55 that overlaps electrode 51 form a parallel plate capacitor 56 with a capacitance that is proportional to the area of overlap. Electrode 52 and a portion of sliding structure electrode 55 that overlaps electrode 52 form a parallel plate capacitor 57 with a capacitance that is proportional to the area of overlap. Electrode 53 and a portion of sliding structure electrode 55 that overlaps electrode 53 form a parallel plate capacitor 58 with a capacitance that is proportional to the area of overlap. Electrode 54 and a portion of sliding structure electrode 55 that overlaps electrode 54 form a parallel plate capacitor 59 with a capacitance that is proportional to the area of overlap.

By measuring the capacitance between sliding structure electrode 55 and each of electrodes 51 through 54, the position of sliding structure electrode 55 relative to electrodes 51 through 54 can be determined. This determination can be made by a secondary input device controller 60, which, for example, can be dedicated to detecting positions of sliding structure electrode 55, or can be implemented by functionality within a host device. For example, secondary input device controller 60 generates a secondary input device delta X value 41 and a secondary input device delta Y value 42. For example, secondary input device delta X value 41 represents current distance of sliding structure electrode 55 in an x direction from a center position. Likewise, secondary input device delta Y value 42 represents current distance of sliding structure 55 in a y direction from the center position.

The use of four electrodes is exemplary. For example, in embodiments in which the sliding structure field of motion is substantially greater than the diameter of the sliding structure, more than four electrodes can be placed on the substrate. Alternatively, three or even two electrodes are a sufficient number to calculate two dimensions of sliding structure location. Capacitance measurements between each electrode and the sliding structure can be used to determine the sliding structure position as described above.

For example, the electrical connection to sliding structure electrode 55 (shown in FIG. 5) on the bottom of sliding structure 11 (shown in FIG. 3) can be eliminated in embodiments that measure the capacitive coupling between each pair of electrodes on surface 12. That is, the capacitance between electrodes 51 and 52 can be measured separately from the capacitance between electrodes 51 and 53, and so on. Four measurements between adjacent electrodes provide information to solve for each of four capacitances, and thereby determine the sliding structure position.

For example, sliding structure electrode 55 is preferably circular in shape to reduce errors arising from the shape of the electrode. Restoring springs 13 allow sliding structure 11 to rotate somewhat. If the user's finger is not centered on sliding structure 11 during the motion of sliding structure 11, the resultant torque can cause the sliding structure 11 to rotate slightly. If sliding structure electrode 55 is circularly symmetric, such rotations will not alter the result of the position measurement. If, on the other hand, sliding structure electrode 55 is not circularly symmetric, the overlap between the sliding structure and the various electrodes will be different for different rotations, even though the center of sliding structure 11 is at the same location in each case. Nevertheless, other sliding structure electrode shapes can be used where this advantage is not desired.

The size and shape of sliding structure 11 can be optimized, for example, to a user's needs and/or desires. For example, optimal size of sliding structure 11 for a particular user may depend on their finger size, dexterity and so on. Logos and so on can be placed on sliding structure 11 allowing versatility of user expression.

In the above-described embodiments of the present invention, the position detection is done capacitatively because such measurements are less effected by dirt accumulating on the surface of the electrodes or wear in the surface of the sliding structure or the electrodes, and consume very little power. However, other position detection mechanisms can also be utilized. For example, the pointing device surface can be coded with a resistive layer with electrodes located on four corners of the surface. Conductivity between an electrode on the bottom of the sliding structure and each of the electrodes can be measured to determine the location of the sliding structure on the surface.

The position of the sliding structure in the sliding structure field of motion can also be ascertained using optical sensors such as those used in a conventional optical mouse. The position of the sliding structure in the sliding structure field of motion can also be ascertained using variations in magnetic fields. The preceding examples of suitable positioning mechanisms are provided as examples. However, it will be apparent from the preceding discussion that there are a large number of position-measuring mechanisms that can be utilized without departing from the teachings of the present invention.

In the embodiment shown in FIG. 5 and FIG. 6, secondary input device controller 60 can check pairs of electrodes when determining relative location of sliding structure electrode 55 with respect to electrodes 51 through 54.

For example, when determining relative location of sliding structure electrode 55 in an x direction, secondary input device controller 60 can check total capacitance of electrodes 51 and 52 with respect to sliding structure electrode 55. Alternatively, or in addition, secondary input device controller 60 can check total capacitance of electrodes 53 and 54 with respect to sliding structure electrode 55.

Likewise, when determining relative location of sliding structure electrode 55 in a y direction, secondary input device controller 60 can check total capacitance of electrodes 52 and 53 with respect to sliding structure electrode 55. Alternatively, or in addition, secondary input device controller 60 can check total capacitance of electrodes 51 and 54 with respect to sliding structure electrode 55.

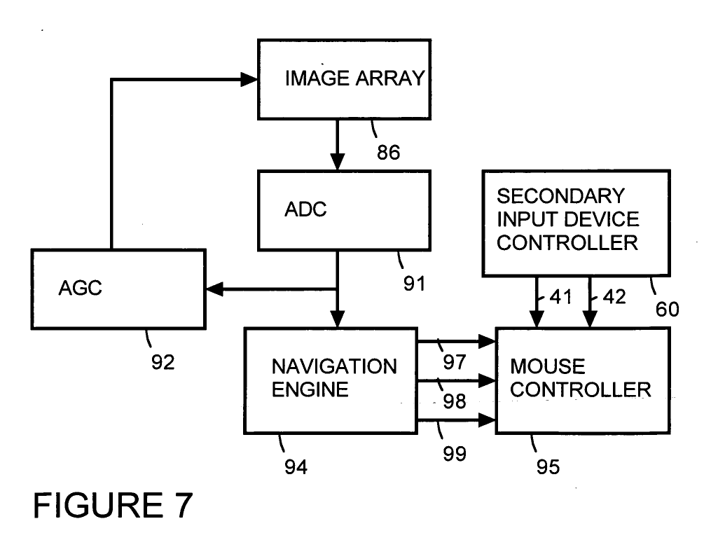

FIG. 7 is a block diagram showing integration of secondary input device secondary input device controller 60 with other components of mouse 10. Image array 86 is implemented, for example, using a 32 by 32 array of photodetectors. Alternatively, other array sizes can be used.

An analog-to-digital converter (ADC) 91 receives analog signals from image array 88 and converts the signals to digital data.

An automatic gain control (AGC) 92 evaluates digital data received from ADC 91 and controls shutter speed and gain adjust within image array 88. This is done, for example, to prevent saturation or underexposure of images captured by image array 88.

A navigation engine 94 evaluates the digital data from ADC 91 and performs a convolution to calculate overlap of images and to determine peak shift between images in order to detect motion. Navigation engine 94 determines a delta x value placed on an output 98 and to determine a delta y value placed on an output 99. Image array 86, ADC 91 and navigation engine 94 together form a tracking device that tracks movements of mouse 80 with respect to an underlying surface.

A mouse controller 95 receives the delta x value placed on output 98 and the delta y value placed on an output 99. Mouse controller 95 also receives secondary input device delta X value 41 and secondary input device delta Y value 42 from secondary input device controller 60. Mouse controller forwards representatives of these values to a host computer along with other selection and movement information from mouse 80.

Existing optical mice include functionality identical or similar to image array 88, ADC 91, AGC 92 and navigation engine 94. For further information on how this standard functionality or similar functionality of optical mice are implemented, see, for example, U.S. Pat. No. 5,644,139, U.S. Pat. No. 5,578,813, U.S. Pat. No. 5,786,804 and/or U.S. Pat. No. 6,281,882 B1. As indicated above, optical implementation of mouse 80 is exemplary. Mouse 80 can be implemented, for example, as a traditional mouse with a roll ball, or can be implemented with another technology used to track position of mouse 80 on a surface.

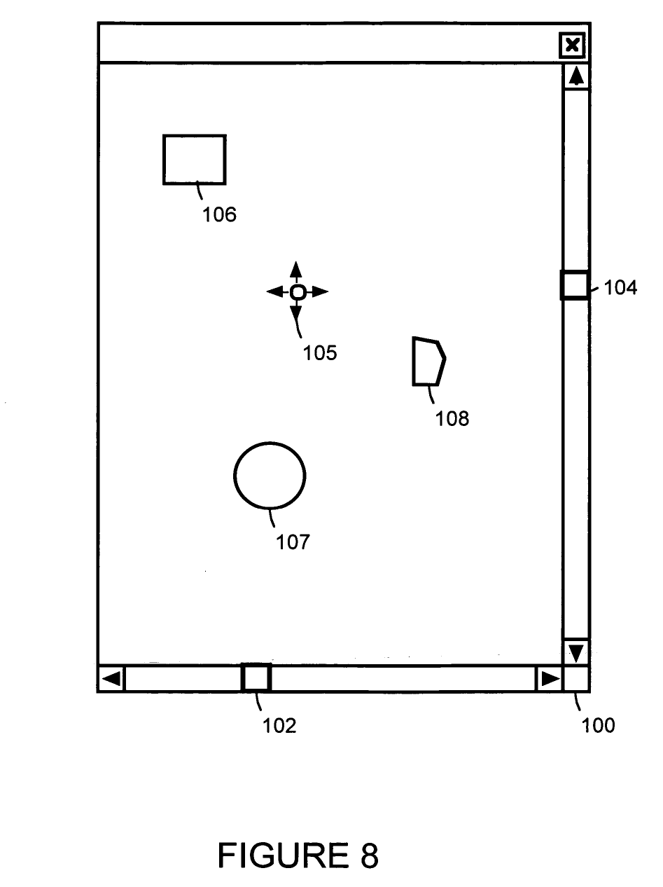

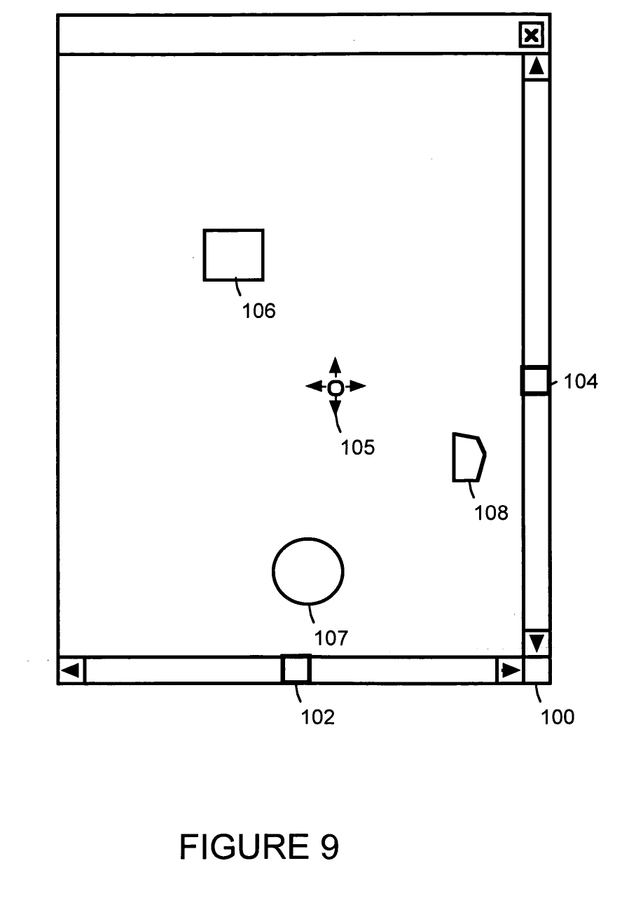

FIG. 8 and FIG. 9 illustrate panning within a computer window 100. Window 100 includes a vertical scroll bar 104 and a horizontal scroll bar 102. In FIG. 8, an object 106, an object 107 and an object 108 represent the current contents of window 100. Cursor 105 is an example cursor shape that results when secondary input device 10 (shown in FIG. 1) is activated. FIG. 9 shows the result of moving cursor 105 using secondary input device 10. As can be seen by comparing FIG. 9 with FIG. 8, as cursor 105 has been moved down and to the right, the contents of window 100 (represented by objects 106, 107 and 108) have moved with cursor 105. This movement of the contents of window 100 (represented by objects 106, 107 and 108) along with cursor 105 is referred to herein as panning. The position of vertical scroll bar 104 and horizontal scroll bar 102 adjusts to reflect the panning of the contents of window 100.

In addition to panning, secondary input device 10 can be used for additional functions. For example, in separate modes, secondary input device 10 can function similar to a joystick or similar to a rocker switch. In joystick mode and rocker switch mode, the position of sliding structure 11 is mapped to the velocity of the cursor. For example, when sliding structure 11 is held at a constant non-centered position, the cursor will travel with a certain velocity based on the radial distance of sliding structure 11 to a center position. The direction of cursor movement is based on the direction of a vector from the center position to current position of sliding structure 11. In an alternative mode, when sliding structure 11 is held at a constant non-centered position, panning will occur with a certain velocity based on the radial distance of sliding structure 11 to a center position.

For example, for small work spaces, a special mode can be used so that movement of sliding structure 11 can be used instead of mouse movements to control pointing of a cursor on a display.

Mixed operation modes can also be utilized. For example, when sliding structure 11 is within a first circumference of movement space, secondary input device 10 can act so that there is a direct mapping between movement of sliding structure 11 and movement of the cursor on a display. When sliding structure 11 is outside the first circumference of movement space, secondary input device 10 can act as in joystick mode where the position of sliding structure 11 is mapped to the velocity of the cursor.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A mouse input device comprising:
a tracking device that tracks movement of the mouse input device over an underlying surface; and,
a secondary input device located on a surface of the mouse input device, the secondary input device having a sliding structure, wherein a magnitude and a direction of motion of the sliding structure with respect to the surface of the mouse input device is monitored.

2. A mouse input device as in claim 1 wherein the secondary input device is also implemented to control panning of contents of an active window on a computer display.

3. A mouse input device as in claim 1 wherein the secondary input device is also implemented to control zooming.

4. A mouse input device as in claim 1 wherein the tracking device includes an image array.

5. A mouse input device as in claim 1 wherein vertical pressure on the sliding structure causes the secondary input device to activate.

6. A mouse input device as in claim 1 wherein springs are used to re-center the sliding structure.

7. A mouse input device as in claim 1 additionally comprising:
a secondary input device controller that determines a location of the sliding structure with respect to the surface of the mouse input device; and,
a mouse controller that receives output from the tracking device and output from the secondary input device controller.

8. A mouse input device as in claim 1 wherein activation of the secondary input device causes a cursor within the active window to change to a special shape that indicates the secondary input device has been activated.

9. A mouse input device as in claim 1 wherein the secondary input device can operate in multiple modes, including a joystick mode where a position of the sliding structure is mapped to velocity of a cursor.

10. A mouse input device as in claim 1 wherein size of the sliding structure can be selected by a user.

11. A mouse input device comprising:
means for tracking movement of the mouse input device over an underlying surface; and,
means for providing a secondary input based on a magnitude and a direction of motion of a sliding structure with respect to a surface of the mouse input device.

12. A mouse input device as in claim 11 wherein vertical pressure on the sliding structure causes activation of the means for providing a secondary input.

13. A mouse input device as in claim 11 wherein the means for providing a secondary input is used to control panning.

14. A mouse input device as in claim 11 wherein activation of the means for providing a secondary input causes a cursor within the active window to change to a special shape that indicates the means for providing a secondary input has been activated.

15. A method comprising:
tracking movement of the mouse input device over an underlying surface; and,
providing a secondary input based on a magnitude and a direction of motion of a sliding structure with respect to a surface of the mouse input device.

16. A method as in claim 15 additionally comprising:
controlling zooming of the contents of the active window based on the magnitude and the direction of motion of the sliding structure with respect to the surface of the mouse input device.

17. A method as in claim 15 additionally comprising:
activating control of panning as a result of application of vertical pressure on the sliding structure.

18. A method as in claim 15 additionally comprising:
re-centering the sliding structure using springs.

19. A method as in claim 15 additionally comprising:
controlling panning of the contents of the active window based on the magnitude and the direction of motion of the sliding structure with respect to the surface of the mouse input device.

20. A method as in claim 15 additionally comprising:
operating in multiple modes, including a joystick mode where a position of the sliding structure maps to velocity of a cursor.
